(19) United States
(12) Patent Application Publication
(10) Pub. No.: US 2006/0005237 A1
(43) Pub. Date: Jan. 5, 2006

(54) Securing computer network communication using a proxy server

(76) Inventors: Hiroshi Kobata, Brookline, MA (US); Robert Gagne, Boston, MA (US)

Correspondence Address: FISH & RICHARDSON P.C., P.O. BOX 1022, MINNEAPOLIS, MN, 55440-1022, US

(21) Appl. No.: 10/766,871

(22) Filed: Jan. 30, 2004

Related U.S. Application Data
(60) Provisional application No. 60/443,562, filed on Jan. 30, 2003.

(51) Int. Cl. G06F 15/16

(52) U.S. Cl. 726/12

(57) ABSTRACT

Techniques are provided for using an authentication proxy server for a destination server to authenticate the identity of the user of a client system based on a digital certificate and a user password. The authentication proxy server also cryptographically associates a digital signature with hardware of a particular client system and later authenticates the hardware of the client system based on the digital signature associated with the hardware. When these techniques are combined with authenticating the destination server based on a digital certificate and authentication the encryption of communications between a browser of the a client system and the a destination server, an authenticated identity for an application user may be provided to the application and the need for the application to request and authenticate a user identifier and password is eliminated.

### CROSS REFERENCE TO RELATED APPLICATIONS

This application claims priority from U.S. Provisional Application No. 60/443,562, titled “VCN Web” and filed Jan. 30, 2003, which is incorporated by reference in its entirety.

### TECHNICAL FIELD

This description relates to securing network communications between two computer systems.

### BACKGROUND

The Internet is an international collection of interconnected networks that provides connectivity among millions of computer systems. One part of the Internet is the World Wide Web (“Web”), a graphics and sound-oriented technology used by computer systems to access a vast variety of digital information, such as documents, files, images and sounds that are stored on other computer systems. The computer systems storing digital information may be referred to as “Web sites” or “Web servers.” A Web server includes electronic pages or documents which may be referred to as “Web pages.” The digital information also may be referred to as digital content or Web content.

Computer system users can view digital information at Web servers through a graphical user interface produced by executing client software called a “browser.” Examples of commercially-available browsers include Netscape Navigator from Netscape Communications Corporation of Mountain View, Calif. and Internet Explorer from Microsoft Corporation of Redmond, Wash. Web browsers use a variety of standardized methods for addressing and communicating with Web servers. The standardized communication methods may be referred to as protocols. A common protocol for publishing and viewing linked text documents is the HyperText Transfer Protocol (HTTP).

To access a Web page at a Web server, a computer system user enters the address of the Web page, called a Uniform Resource Locator (URL), in an address box provided by the Web browser. The URL can specify the location of a Web server or a file on a Web server. An accessed Web page may include a combination of text, graphics, audio and video information (e.g., images, motion pictures, and animation). The accessed Web page may have links to other documents at other Web pages on the same or a different Web server. Also, an accessed Web page may invoke the execution of an application program.

One approach to communicating over a network, such as the Internet, is to use a protocol stack that includes multiple layers of communication messages that are exchanged during a communication process from a sending system to a receiving system, such as a communication process from a client system to a Web server or another type of destination server. One example of a communication protocol stack is the International Standards Organization (ISO) Open Systems Interconnection (OSI) reference model. Another example of a communication protocol stack is a five-layer communication protocol stack that often is used to communicate over the Internet.

The five-layer communication protocol stack includes an application layer, a transport layer, a network layer, a data link layer, and a physical layer. Information is transmitted from a sending system to a receiving system through the five layers of the communication protocol stack. More specifically, information in the sending system is passed from an application program at the application layer to the transport layer. The application layer often includes an application program that uses HTTP to access a Web page that is specified by a URL. The access request is passed to the transport layer, such as the Transport Control Protocol (TCP) portion of the TCP/IP (Internet Protocol) protocol used in Internet communications. The access request is then passed from the transport layer through the network layer and the data link layer to a physical layer. The access request is then sent over a physical connection, which may be a direct connection or an indirect connection, to the receiving system (i.e., the Web server). The messages are passed up through the receiving system's communication protocol stack beginning with the physical layer until the access request reaches the application layer where the access request is fulfilled or otherwise processed.

One approach to securing network communications is through the use of a secure socket layer (SSL) originally developed by Netscape Communications Corporation. SSL is a security layer that is located between the transport layer and the application layer and used to secure communications between a sending system and a destination server or another type of receiving system. More specifically, SSL is a security layer that is located between the HTTP and TCP layers of an Internet communication protocol stack. SSL often is included as part of browser applications, such as Netscape Navigator or Internet Explorer. SSL employs a security protocol that enables encrypted communications between a sending system and a destination server. When SSL is used for communication, the HyperText Transmission Protocol, Secure (HTTPS) is used to support application-layer access to a URL. Optionally, SSL may be used to authenticate the identity of a Web server or another type of destination server by requiring the server provide a digital certificate. SSL also may be used to authenticate the sending system by requiring the sending system provide a digital certificate.

A digital certificate uses public key cryptography to authenticate the identity of a communicating party. A digital certificate for a particular identity is issued by a certification authority (CA). The identity presents the digital certificate and the identity's public key to an authenticating service that uses the digital certificate and public key to confirm the identity of the presenter of the public key.

A certificate authority (CA) issues a digital certificate to an entity (which may be referred to as the digital certificate holder) to allow the entity to prove its identity to another entity (that is, the authenticating entity). The certificate authority is a business entity, and the entity to whom the digital certificate is issued is an organization or an individual. The certificate authority verifies the identity of an entity requesting a digital certificate and issues a digital certificate that attests to the identity of the entity. The digital certificate issued by the certificate authority includes the public key of the identity that has been encrypted with the certificate authority's private key. To authenticate the identity, the certificate authority's public key is used to decrypt the public key of the identity and compare the decrypted key with the public key provided by the identity.

Additionally, a digital certificate holder that presents a digital certificate may prove its identity by demonstrating that the digital certificate holder has a private key that corresponds to the public key included in the digital certificate. For example, an entity may send a cryptographic hash of content that is known both to the entity and the certificate-receiving entity. The content hashed may be the public key information, a message being transmitted, or the contents of previous messages exchanged between the digital certificate holder and the authenticating entity. The digital certificate holder uses the digital certificate holder's private key to encrypt the hashed content and sends the encrypted content to the authenticating entity (which also may be referred to as the certificate-receiving entity). The authenticating entity uses the public key of the digital certificate holder to decrypt the hashed content. The authenticating entity then cryptographically hashes the same content and compares the two versions of the hashed content. When the two versions of the hashed content correspond to one another, the identity of the digital certificate holder providing the certificate is proven.

Also, a sender of a document or other digital information may use the sender's private key to encrypt a hash of the document and append the encrypted hash to the document. The encrypted hash may be referred to as a digital signature, and the unencrypted hash of the document may be referred to as a message digest. The recipient of the document uses the public key of the sender to decrypt the digital signature appended to the document and to reveal the message digest. The document recipient then cryptographically hashes the document to generate another version of the message digest. The two versions of the message digest are compared, and, when the two versions correspond to one another, the identity of the sender of the document is verified.

### SUMMARY

[Summary to be Completed Once Claims Have Been Finalized]

Implementations of the techniques described may include a method or process, an apparatus or system, or computer software on a computer-accessible medium. The details of one or more implementations are set forth below. Other features will be apparent from the description and drawings, and from the claims.

### DESCRIPTION OF DRAWINGS

FIG. 1 is a block diagram of a communications system capable of authenticating a user identity by executing software logically operating between an application layer and a transport layer of a layered communication protocol.

FIG. 2 is a diagram depicting an example digital certificate.

FIG. 3 is an expansion of the block diagram of FIG. 1.

FIG. 4 is a block diagram depicting a communications system that uses load balancing techniques to spread authentication tasks across multiple authentication proxy servers.

FIG. 5 is a block diagram illustrating communications between a browser of a client system, a communication proxy server, and a security naming server to assign a network connection request from the client system to a particular authentication proxy server.

FIG. 6 is a block diagram illustrating communications between a browser of a client system, a communication proxy server, an authentication proxy server, a security information server and a destination server to authenticate a user identity associated with the client system.

FIG. 7 is a block diagram illustrating a communications system that supports the exchange of electronic documents only after the user associated with the sending system has been authenticated using a digital certificate.

FIG. 8 is a block diagram illustrating communications between a client system and an authentication proxy server to generate and verify a hardware lock for a digital certificate associated with the client system.

### DETAILED DESCRIPTION

Techniques are provided for using an authentication proxy server for a destination server to authenticate the identity of the user of a client system based on a digital certificate and a user password. The authentication proxy server also cryptographically associates a digital signature with hardware of a particular client system and later authenticates the hardware of the client system based on the digital signature associated with the hardware. When these techniques are combined with authenticating the destination server based on a digital certificate and the encryption of communications between a browser of the client system and the destination server, an authenticated identity for an application user may be provided to the application and the need for the application to request and authenticate a user identifier and password is eliminated.

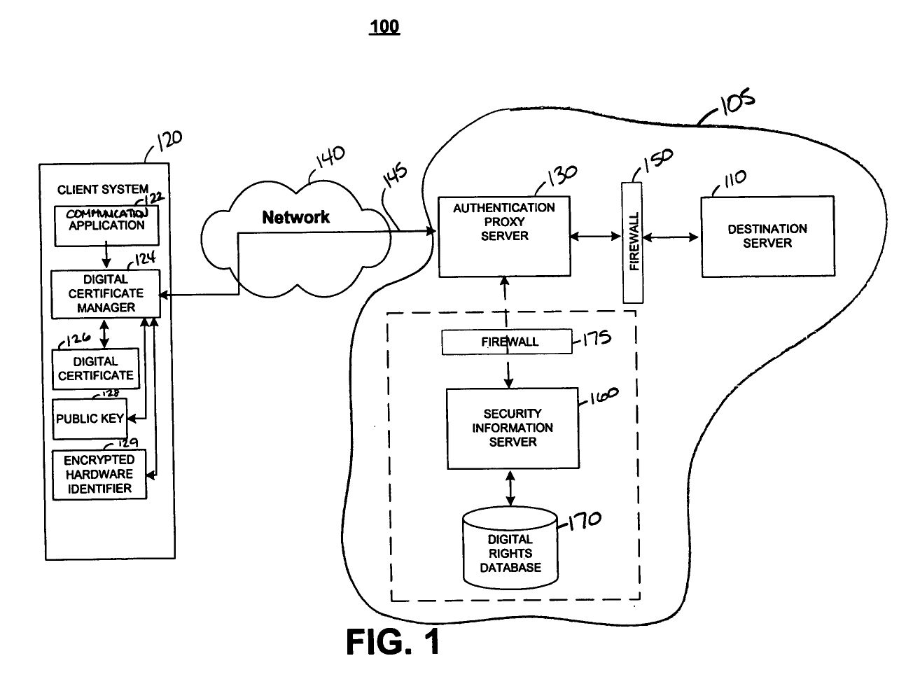

Referring to FIG. 1, a communications system 100 is capable of authenticating the identity of a user seeking access to a destination server 110 from a client system 120 using a protocol that is located between the application layer and the transport layer of a layered communication protocol. The communications system 100 also is capable of authenticating the hardware used to access the destination server 110—that is, determining that the hardware of the client system 120 is permitted by the destination server 110 to be used for such access.

The destination server 110 may include one or more general-purpose computers, one or more special-purpose computers (e.g., devices specifically programmed to communicate with each other and/or the client system 120), or a combination of one or more general-purpose computers and one or more special-purpose computers. The destination system 110 may be arranged to operate within or in concert with one or more other systems, such as, for example, one or more LANs (“Local Area Networks”) and/or one or more WANs (“Wide Area Networks”).

The client system 120 includes a communication application 122, a digital certificate manager 124, and a digital certificate 126. The communication application 122 may be a browser or another type of application that is capable of accessing the client-side certificate manager 124. For example, the communication application may be configured to use the digital certificate manager 124 to communicate with secure receiving systems.

The digital certificate 126 of the client system 120 is a digital certificate that has been issued by a certificate authority. The digital certificate 126 may use a standardized format, such as a version of the X.509 certificate protocol as defined by the Internet Engineering Task Force. The digital certificate 126 includes the public key 128 of the client system 120 that has been encrypted using the certificate authority's public key. The digital certificate 126 and the public key 128 of the client system 120 are presented by the client system 120 to authenticate the identity of the user to an authentication proxy server 130, as described below.

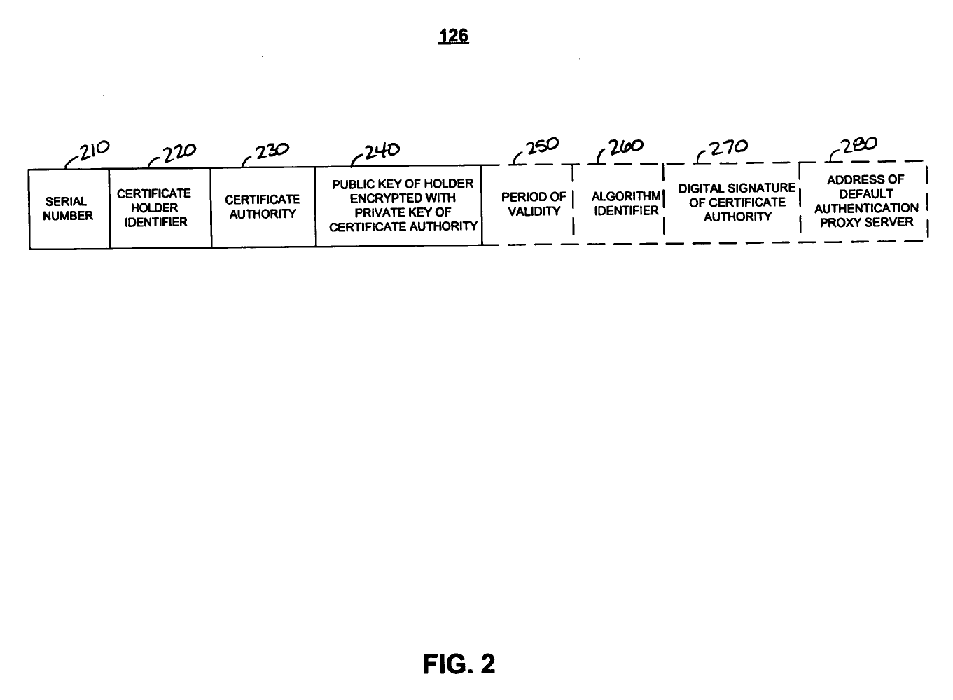

FIG. 2 illustrates an example of a digital certificate 126. The digital certificate 126 provides a public key that may be used to authenticate the identity corresponding to the digital certificate 126. The digital certificate 126 includes a serial number 210, a holder identifier 220, a certificate authority 230, the public key 240 of the holder that is encrypted with the private key of the certificate authority, an optional period of validity 250, an optional algorithm identifier 260, an optional digital signature 270 of the certificate authority, and an optional address 280 of a default authentication proxy server.

The serial number 210 uniquely identifies the digital certificate issued by the certificate authority 230.

The holder identifier 220 identifies the entity to whom the digital certificate was issued.

The public key 240 of the digital certificate holder is encrypted with the private key of the certificate authority. The public key 240 may be used to authenticate the digital certificate holder. For example, a recipient of the digital certificate may use the public key of the certificate authority to decrypt the public key of the digital certificate holder. The recipient then may use the decrypted public key to encrypt a value that may only be decrypted using the private key of the digital certificate holder. The recipient of the digital certificate may provide the encrypted value to the digital certificate holder. When the digital certificate holder returns a decrypted version of the value, the digital certificate holder proves its identity to the recipient of the digital certificate.

The optional period of validity 250 indicates the time period during which the digital certificate is valid. The period of validity 250 may include an indication of the starting date of the period of validity and/or the ending date of the period of validity.

The optional algorithm identifier identifies a cryptographic algorithm to be used to decrypt the public key of holder 240 and also may identify parameters used by the algorithm.

The digital signature 270 of the certificate authority may be used to verify that the digital certificate is valid.

The address 280 of a default authentication proxy server is optional. The address 280 may be used to direct a user authentication request to a particular authentication proxy server.

The client system also includes an encrypted hardware identifier 129. The encrypted hardware identifier 129 is associated with a component of the hardware of the client system. The encrypted hardware identifier is presented by the client system 120 to authenticate the hardware being used to access the destination server 110. The encrypted hardware identifier 129 may be referred to as a hardware digital signature.

Referring again to FIG. 1, the client system 120 communicates over a network 140 that provides a direct or indirect communication link between the client system 120 and the authentication proxy server 130, irrespective of physical separation. Examples of the network 140 include the Internet, the World Wide Web, WANs, LANs, analog or digital wired and wireless telephone networks (e.g., PSTN (“Public Switched Telephone Network”), ISDN (“Integrated Services Digital Network”), and DSL (“Digital Subscriber Line”) including various forms of DSL such as SDSL (“Single-line Digital Subscriber Line”), ADSL (“Asymmetric Digital Subscriber Line”), HDSL (“High bit-rate Digital Subscriber Line”), and VDSL (“Very high bit-rate Digital Subscriber Line)), radio, television, cable, satellite, and/or any other delivery mechanism for carrying data. Communications pathway 145 enables communications through the network 140. The communications pathway 145 may include, for example, a wired, wireless, virtual, cable or satellite communications pathway over the network 140. The communications over the communications pathway 145 are encrypted.

A user of client system 120 initiates the communication application 122 to access a secure destination server. The communication application 122 is configured to call the digital certificate manager 124. The digital certificate manager 124 then sends the digital certificate 126 and the public key 128 of the client system 120 to the authentication proxy server 130 over the network 140.

The authentication proxy server 130 receives the digital certificate 126 and the public key 128. Using the digital certificate 126 and the public key 128, the authentication proxy server 130 authenticates the user identity of the client system 120. For example, the authentication proxy server 130 uses the certificate authority's public key to decrypt the public key of the identity included in the digital certificate. The authentication proxy server 130 then compares the decrypted key with the public key provided by the identity. When the decrypted key corresponds to the public key provided by the identity, the identity is authenticated.

Additionally, the client system 120 may prove its identity by demonstrating that the client system 120 has a private key that corresponds to a public key included in the digital certificate provided to the authentication proxy server 130. For example, the client system 120 may send a cryptographic hash of content that is known both to the client system 120 and the authentication proxy server 130, as described previously. The authentication proxy server 130 then cryptographically hashes the same content and compares the two versions of the hashed content to authenticate the client system 120 based on a correspondence between the private key of the client system 120 and the public key in the digital certificate provided to the authentication proxy server 130.

The user identity of the client system 120 also provides a password associated with the user to the authentication proxy server 130. Typically, a message digest of the password or an encrypted version of the password is transmitted to the authentication proxy server 130. The authentication proxy server 130 then also authenticates the user identity based on the password provided during the communication session.

The client system 120 also sends the encrypted hardware identifier to the authentication proxy server 130. The authentication proxy server 130 authenticates the hardware of the client system being used for access based on the hardware identifier provided during the communication session.

When the user identity and the hardware of the client system 120 are not authenticated, the authentication proxy server 130 may take any of several actions, including terminating the connection with the client system 120 or sending a message to the client system 120 to indicate that the client system 120 is not permitted access to the destination server 110.

When the user and the hardware of the client system 120 are authenticated, the authentication proxy server 130 provides access to the destination server 110 through a firewall 150. The firewall 150 is located between the authentication proxy server 130 and the destination server 110. The firewall 150 inspects incoming messages and approves or rejects messages to protect the destination server 110. Some implementations may use security techniques other than a firewall to inspect incoming messages and approve or reject messages to protect the destination server 110. The firewall 150 is configured to allow communications between the authentication proxy server 130 and the destination server 110.

Optionally, the authentication proxy server 130 may determine the digital rights of the authenticated identity with respect to the content on the destination server 110. For example, digital rights may be restricted such that one or more of printing, downloading, forwarding, and/or generating screen captures of the digital content is not permitted. In one example, the authentication proxy server 130 may access a security information server 160 to determine the access rights for the digital content, based on the identity of the client 120 and/or the digital content itself. The authentication proxy server 130 accesses the security information server 160 through a firewall 175 that is located between the security information server 160 and the authentication proxy server 130. The firewall 175 is configured to allow communications between the authentication proxy server 130 and the security information server 160.

The capability of the authentication proxy server to determine the digital rights of an authenticated identity or a web site may be useful. For example, the ability to limit any user to a particular web site (or to limit a particular user accessing a particular web site) to only viewing information on the web site, browsing or otherwise navigating through the information on the web site, and providing information to the web site may be useful. In the context of providing customer service, a customer service agent so restricted may be able to view customer information and update customer information. The customer service agent, however, is restricted from copying, downloading, or otherwise replicating digital customer information on the destination server. This may help to reduce the loss of customer information that occurs when on a customer service agent misappropriates digital information about customers.

The security information server 160 accesses a digital rights database 170 to determine the particular digital rights associated with the digital content. For example, the security information server 140 may access one or more access control lists that define the type of access and use that is permitted with respect to the digital content on the destination server 110. For example, some digital content may only be viewable and may not be printed, forwarded, or used to generate a screen capture. Alternatively or additionally, an access control list may control access to digital content based on the identity of a user or a group to which the user belongs.

The security information server 160 provides the results of the digital rights determination to the authentication proxy server 130. The authentication proxy server 130 then provides the appropriate level of access to the authenticated identity.

In combination with a secure socket layer protocol, the techniques for authentication of the user identity of the client system provide both user authentication and destination server authentication through the use of a digital certificate to authenticate the destination server and a different digital certificate to authenticate the user. This may help improve the security of the destination server as compared with application-layer security mechanisms.

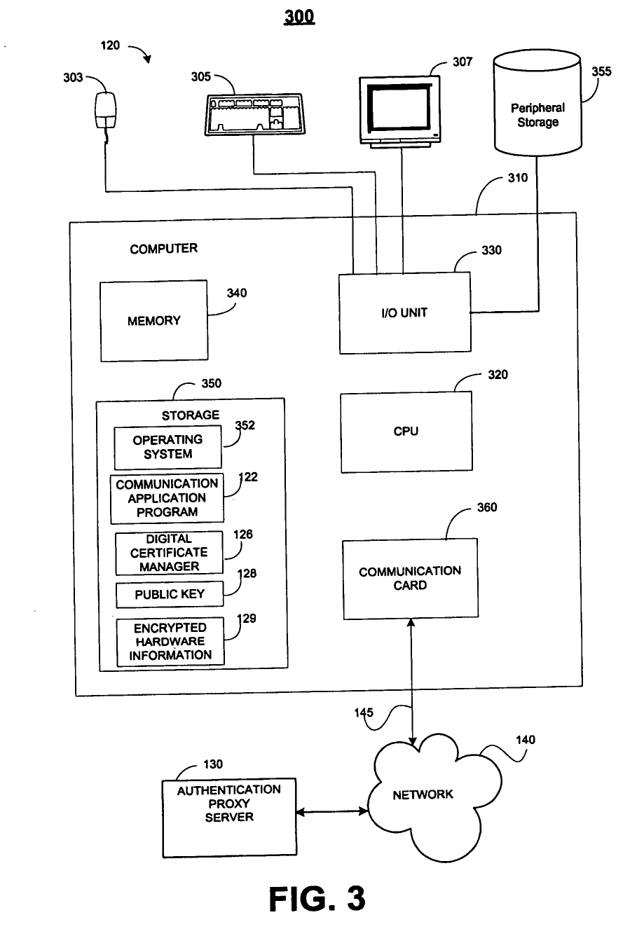

FIG. 3 illustrates a communication system 300 including a client system 120 communicating with an authentication proxy server 130 through a network 140. The client system 120 includes a variety of input/output (I/O) devices (e.g., a mouse 303, a keyboard 305, and a display 307) and a computer 310 having a central processor unit (CPU) 320, an I/O unit 330, a memory 340, and a data storage device 350. The data storage device 350 may store machine-executable instructions, data, and various programs, such as an operating system 352 and one or more communication application programs 354, for implementing a process for communicating with the authentication proxy server 130, all of which may be processed by CPU 320. Each computer program may be implemented in a high-level procedural or object-oriented programming language, or in assembly or machine language if desired; and, in any case, the language may be a compiled or interpreted language. The data storage device 350 also includes a digital certificate manager 126 a public key 128, and an encrypted hardware identifier 129. The data storage device 350 may be any form of non-volatile memory, including, for example, semiconductor memory devices, such as Erasable Programmable Read-Only Memory (EPROM), Electrically Erasable Programmable Read-Only Memory (EEPROM), and flash memory devices; magnetic disks, such as internal hard disks and removable disks; magneto-optical disks; and Compact Disc Read-Only Memory (CD-ROM).

The client system 120 may include one or more peripheral online storage devices 355. A peripheral online storage device 355 may use any storage media (including magnetic, optical or solid state storage media) or any type of storage device (including a drive, a microdrive, a compact disc (CD), a recordable CD (CD-R), a rewriteable CD (CD-RW), a flash memory, or a solid-state floppy disk card (SSFDC)).

The client system 120 also may include a communications card or device 360 (e.g., a modem and/or a network adapter) for exchanging data with a network 140 using a communications link 145 (e.g., a telephone line, a wireless network link, a wired network link, or a cable network). Other examples of computer 310 may include a handheld device, a workstation, a server, a device, a component, other equipment, or some combination of these capable of responding to and executing instructions in a defined manner. Any of the foregoing may be supplemented by, or incorporated in, ASICs (application-specific integrated circuits).

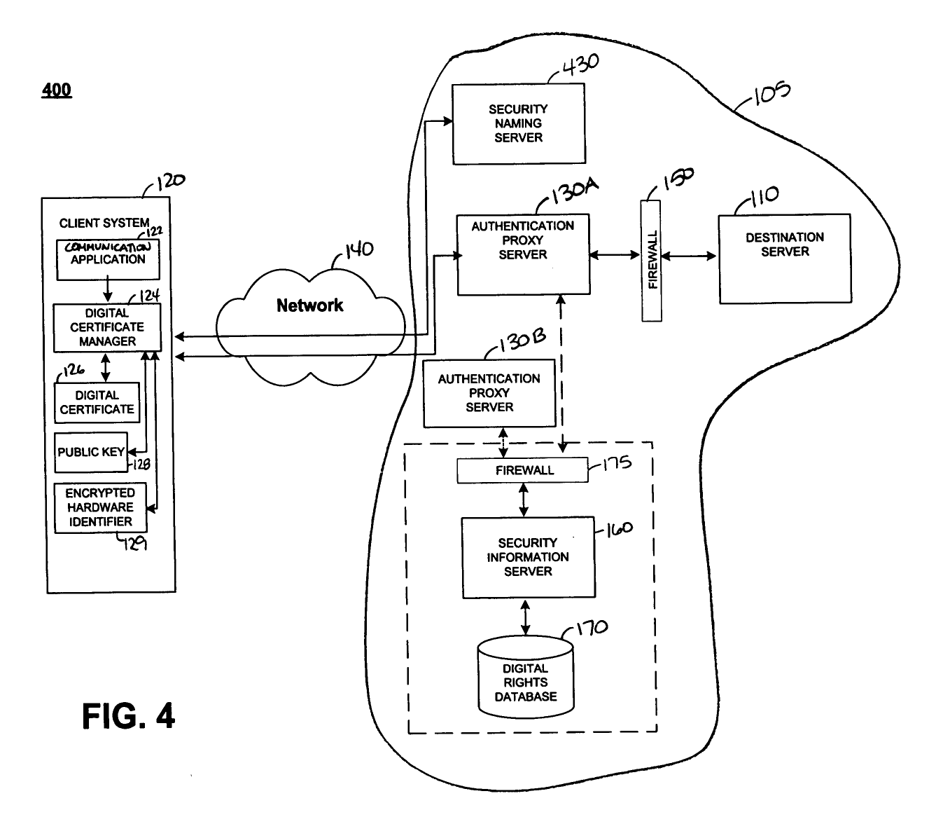

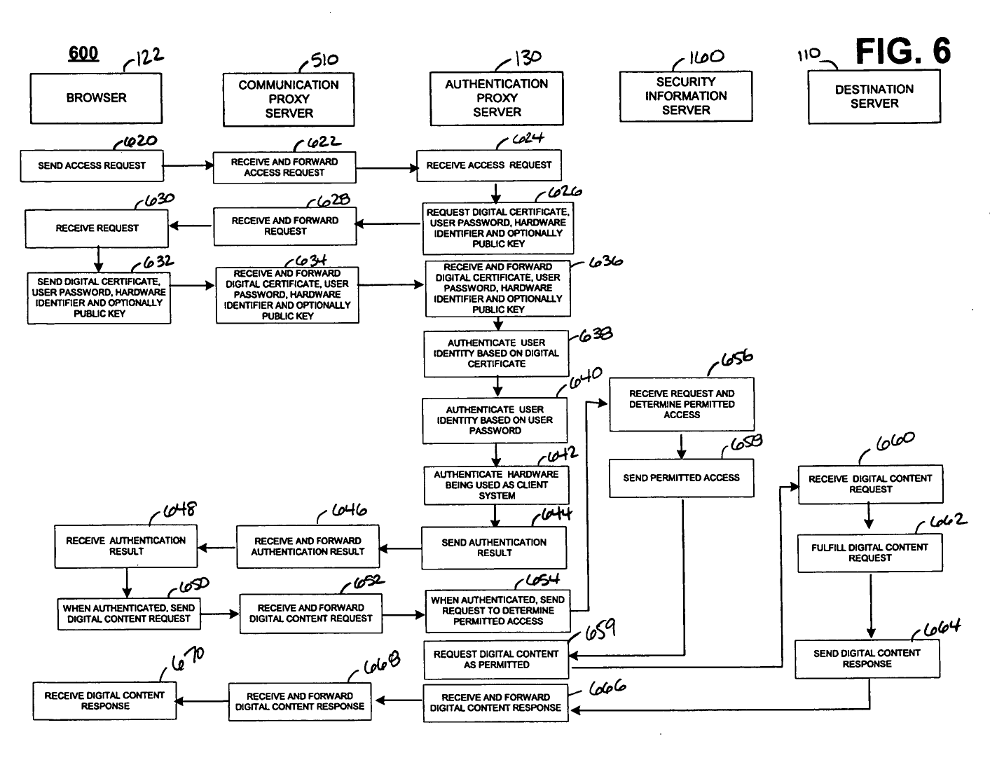

FIG. 4 illustrates a system 400 for distributing user authentication tasks across multiple authentication proxy servers. In general, when the client system 120 seeks access to the destination system 110, the client system 120 is authenticated by a authentication proxy server as determined by the security naming server 430. The client system 120 is authenticated based on a digital certificate associated with the client system 120, a user password, and an encrypted hardware identifier, as described previously with respect to FIG. 1 and described below with respect to FIG. 6.

More specifically, a user of the client system 120 initiates the communication application 122 to communicate with the destination system 110. The communication application 122 is configured to use the digital certificate manager to request from the security naming server 430 the identification of an authentication server 130A or 130B to be used to authenticate the identity of the user of the client system 120.

The security naming server 430 determines one of several authentication servers 130A and 130B to authenticate the user of the client system 120. To do so, the security naming server 430 may use one or more load balancing techniques to distribute the user authentication tasks from multiple client systems across multiple authentication proxy servers. For example, the security naming server 430 may use a round-robin scheduling technique that directs a network connection to a different authentication proxy server according to a predetermined rotation sequence that is independent of the number of connections or the response time of each of the authentication proxy servers.

The security naming server 430 also may use a weighted round-robin scheduling technique that takes into account the processing capabilities of the each of the authentication proxy servers. An integer value that indicates the processing capability may be assigned to each authentication proxy server, and the authentication tasks may be assigned based on the relative integer values of each authentication proxy server. For example, a scheduling sequence of assigning authentication tasks may be generated based on the relative weights of each of the authentication proxy servers. In some cases, the weighted round-robin scheduling technique may lead to load imbalances, particularly when the level of requests varies greatly.

The security naming server 430 also may use a least-connection scheduling technique that directs an authentication task to the authentication proxy server that has the least number of established connections. In a TCP implementation of authentication proxy servers of varying capabilities in which the level of requests varies greatly, the least-connection scheduling technique may lead to load imbalances when the TCP TIME_WAIT state is set too high.

The security naming server 430 also may use a weighted least-connection scheduling technique that assigns a performance weight to each authentication proxy server. A higher performance weight for an authentication proxy server results in a larger percentage of authentication tasks being assigned to that server at one time. An authentication task is directed to an authentication proxy based on a ratio of the percentage of the authentication tasks being performed by each authentication proxy to the performance weight assigned to the authentication proxy server.

The security naming server 430 also may use different load balancing techniques to distribute authentication tasks across multiple authentication proxy servers. For example, in lieu of or in addition to the assignment of an authentication task to a particular authentication proxy server when an authentication task is initiated, an authentication task running on a particular authentication proxy server may be migrated to another authentication proxy server to improve system performance.

The use of load balancing techniques may improve the scalability of the system for authenticating users by allowing the use of additional servers to spread the volume of work over more processing capability, which, in turn, may improve system response time. In addition, the use of load balancing techniques may increase the level of fault tolerance by providing one or more redundant authentication proxy servers that may continue to operate in the event that a single authentication proxy server fails.

In some implementations, the authentication proxy servers 130A and 130B may access one or more servers to obtain information to authenticate a user. The accessed servers may be referred to as user servers. When more than one user server is accessed by the authentication proxy servers 130A and 130B, a digital certificate may be associated with a particular user server. When a client system 120 is used to access more than one user server, multiple digital certificates may need to be installed on the client system 120, with one digital certificate for each user server that is used by each of the authentication proxy servers 130A and 130B to authenticate the user.

Some implementations may use additional or alternate techniques for selecting a particular authentication proxy server to be used to authenticate a user identity associated with a client system. For example, a digital certificate may include an address for a default authentication proxy server, as previously described with respect to FIG. 2. This may be referred to as automatic authentication proxy server selection. In another example, the digital certificate manager 124 or another type of communication application may be configured to use a particular authentication proxy server. This may be referred to as configured authentication proxy server selection. In yet another example, a manual method for authentication proxy server selection may be used such that the user is able to enter an address for a particular authentication proxy server. For example, a user may enter a particular URL in a browser to identify a particular authentication proxy server.

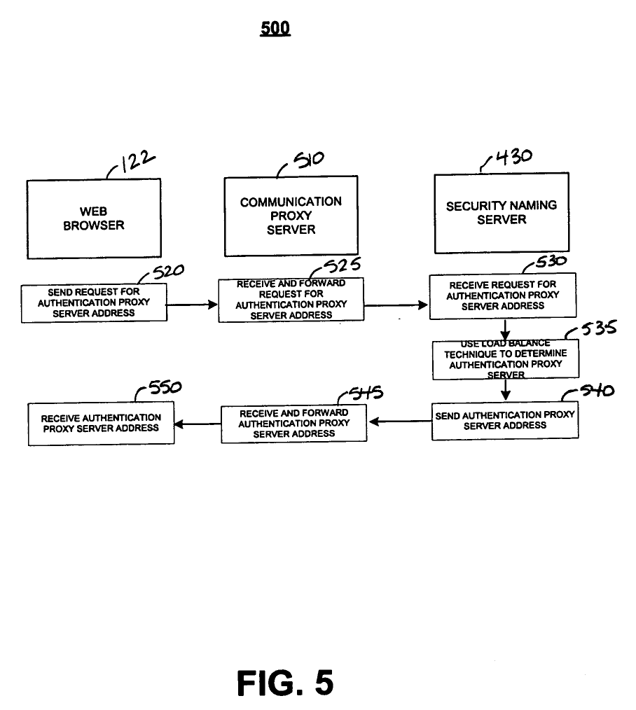

FIG. 5 illustrates an example of a process 500 for directing requests to one of several authentication proxy servers to balance the work load of authenticating users seeking access to a destination system. In this implementation, the destination system is a Web server and a user uses a browser to communicate with the security naming server. The system 500 includes a browser 122 of a client system, a communication proxy server 510, and a security naming server 430. In general, the communication proxy server 510 stores a local copy of a recently-accessed web page. The collection of local copies may be referred to as a local cache. The communication proxy server 510 accepts a URL to identify a desired Web page and searches the local cache of the communication proxy server for the desired Web page. When the URL is not found in the local cache, the communication proxy server sends the request to the destination server to fulfill the request for the Web page. The use of a communication proxy server may help improve response time in fulfilling a request for a Web page.

The process 500 begins when the browser 122 sends to the communication proxy server a request for an authentication proxy server address (step 520). The communication proxy server 510 receives the request and forwards to the security naming server 430 the request for an authentication proxy server address (step 525).

The security naming server 430 receives the request for an authentication proxy server address (step 530). The security naming server 430 then uses a load balance technique to determine a particular authentication proxy server to assign the request (step 535). The security naming server 430 then sends the address of the particular authentication server to the communication proxy server 510 (step 540).

The communication proxy server 510 receives the authentication proxy server address and forwards the address to the browser 122 (step 545). The browser 122 receives the authentication proxy server address (step 550). The browser then directs access requests and digital contact requests to the authentication proxy server address, for example, as described below with respect to FIG. 6.

The use of the communication proxy server 510 is not necessary to the process of directing a request to one of several authentication proxy servers. However, a communication proxy server may be used.

FIG. 6 depicts an example of a procedure 600 for authenticating a client system that initiates a request for a Web page and fulfilling the request only after the user and hardware being used by the user is authenticated. Both the user identity and the hardware of the client system are authenticated. The identity of the user of the client system is authenticated based on a digital certificate and a user password. The hardware of the client system is authenticated based on a digital signature associated with the hardware. In this implementation, the destination system is a Web server and a user is using a Web browser on a client system to communicate with the security naming server. A communication proxy server 510 is located between the browser 122 on the client system and the authentication proxy server 130 and provides a local cache of recently-requested Web pages.

The process 600 begins when the browser 122 of the client system, through the digital certificate manager, sends to the communication proxy server 510 a request for access to the destination server 110 (step 620). The communication proxy server 510 receives the access request and forwards the access request to the authentication proxy server (step 622).

The authentication proxy server 130 receives the access request (step 624) and sends to the communication proxy server 510 a request for authentication information (step 626). More particularly, the authentication proxy server 130 sends a request for a digital certificate that identifies the user of the browser 122, a user password that also identifies the user of the browser, a hardware identifier that identifies the hardware used to access the destination server 110, and, optionally, a public key of the user of the browser (step 626). In some implementations, the authentication proxy server 130 may access the public key of the user from a public registry or storage accessible to the authentication proxy server 130 (such as security information server 160) and may not need to request the public key of the user.

The communication proxy server 510 receives the authentication information request and forwards the request to the browser 122 (step 628).

The browser 122 receives the authentication information request (step 630) and sends to the communication proxy server 510 the requested authentication information (step 632). More specifically, a prompt to enter a user password is displayed by the browser 122, through the digital certificate manager, and, in response, the user enters the password. The digital certificate manager may optionally encrypt the password or create a message digest of the password by cryptographically hashing the password. The browser 122, through the digital certificate manager, then sends the password, the digital certificate associated with the user of the client system, the encrypted hardware identifier associated with the client system, and the public key of the user identity using the browser 122 (when the public key is requested by the authentication proxy server 130) (step 632). The communication proxy server 510 receives the authentication information and forwards to the authentication proxy server 130 the authentication information (step 634).

The authentication proxy server 130 receives authentication information to identify the user of the browser 122 and the hardware being used to access the destination server 110 (step 636). The authentication proxy server 130 authenticates, based on the digital certificate, the user identity using the browser 122 (step 638). This may be accomplished, for example, based on a comparison of the decrypted public key in the digital certification with the provided public key, as described previously with respect to FIG. 1.

The authentication proxy server 130 also authenticates the user identity using the browser 122 based on the user password (step 640). This may be accomplished, for example, based on a comparison the received password and a password associated with the user that is accessible to the authentication proxy server 150 or the security information server 160 (e.g., a password that has been previously stored on one of those servers).

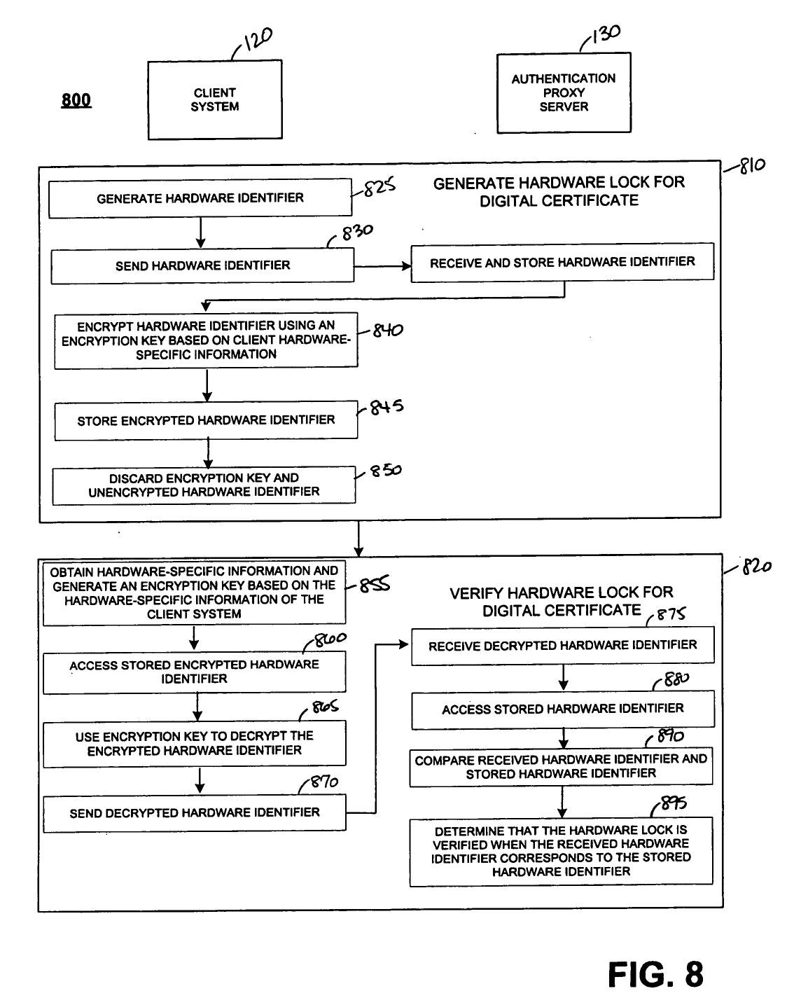

The authentication proxy server 130 also authenticates the hardware being used to access the destination server based on the received hardware identifier (step 642). This may be accomplished, for example, as described below with respect to FIG. 8.

Alternatively, when the browser is being configured for secure communications (e.g., the digital certificate manager is being installed on the client system), a random number may be generated, a message digest created of the random number, and the message digest stored on the client in association with a hardware component for use as a hardware identifier. A copy of the message digest is sent to the authentication proxy server 130 to be stored in association with the identity of the user and for use in later communication sessions by the authentication proxy server 130. Alternatively, the random number may be generated and encrypted (rather than being cryptographically hashed into a message digest).

The authentication proxy server 130 then sends to the communication proxy server 510 the authentication result (step 644)—that is, whether the client system has been authenticated. In some implementations, the authentication result may include more detailed authentication results, such as an indication whether the user identity has been proved based on the digital certificate and/or password and whether the hardware identity has been proven based on the hardware digital signature.

The communication proxy server 510 receives the authentication result and forwards the authentication result to the browser (step 646), which receives the authentication result (step 648). In some implementations, when the user of the browser 122 or the hardware being used is not authenticated, the authentication proxy server 130 or the browser 122 may take any of several actions, including terminating the connection between the browser 122 and the authentication proxy server 130 and/or displaying a message for the user to indicate that the user is not permitted access to the destination server 110, as previously described with respect to FIG. 1.

When the client system has been authenticated, the browser 122, through the digital certificate manager, sends to the communication proxy server 510 a request for a particular Web page that is identified by a uniform resource locator or another type of identified digital content (step 650). The communication proxy server 510 receives the digital content request and forwards the digital content request to the authentication proxy server (step 652).

The authentication proxy server 130 receives the digital content request and, when the client system is authenticated, sends the request to determine the permitted access to the requested digital content (step 654).

The security information server 160 receives the request to determine the type of access that is permitted and determines the permitted access (step 656). The security information server 160 may determine the permitted access by accessing one or more access control lists or another type of digital rights management information, as described previously with respect to FIG. 1. For example, the security information server 160 may limit access based on the particular destination server requested, a portion of a directory structure within a destination server, or by a particular page within a directory. The types of access that may be restricted include, for example, viewing (that is, the content is not accessible in any manner), downloading, forwarding, and/or generating screen captures. Some implementations may use a hierarchical structure in which directory access permission or restriction of a directory that is higher in the hierarchy also is applied to a directory that is lower in the hierarchy. Implementations also may include another type of hierarchical structure for organizing digital content, such as a digital content object structure. In such a case, the access rights associated with a parent object may be inherited or otherwise applied to a child object of the parent object.

The security information server 160 sends to the authentication proxy server the permitted access for the requested digital content (step 658). The authentication proxy server 130 receives the permitted access for the requested digital content and requests from the destination server 110 the digital content in the manner permitted (step 659).

The destination server 110 receives the digital content request (step 660), accesses the requested digital content (step 662), and sends to the authentication proxy server 130 the digital content response (step 664). The authentication proxy server 130 receives the digital content response and forwards to the communication proxy server 510 the digital content response (step 666). The communication proxy server 510 receives the digital content response and forwards to the browser 122 the digital content response (step 668). The browser 122 receives the digital content response (step 670) and makes the digital content available to the authenticated user or otherwise uses the digital content.

The process 600 for authenticating a client system may be implemented without requiring modification to an application operating on a Web site. In addition, the process 600 may be capable of providing the authenticated identity of an application user to the application and eliminating the need for the application to request a user identifier from the user, which the application then authenticates. This may be particularly useful when these techniques are combined with authenticating the destination server based on a digital certificate and encrypting communications between the browser of the client system and the destination server.

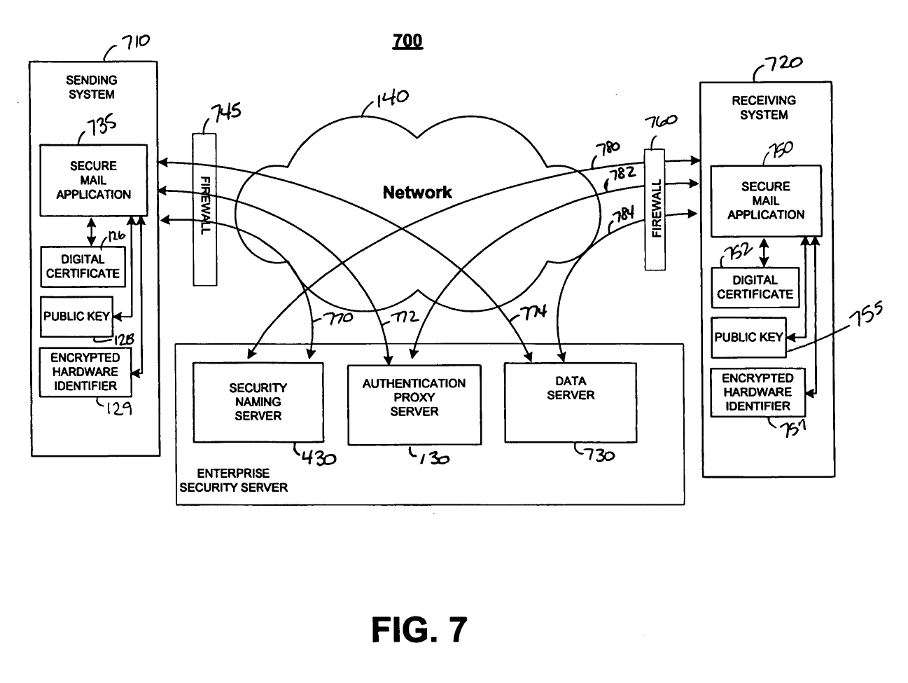

FIG. 7 shows an implementation of authenticating a user and the hardware being used by the user in the context of a electronic document exchange system, such as an electronic mail system. In contrast, previously described implementations showed authenticating a user and the hardware of the client system before permitting a user to access digital content from a destination server. In the communication system 700, an enterprise secure server 705 enables the secure exchange of an electronic document with digital content from the sending system 710 to a receiving system 720.

The enterprise secure server 705 includes a group of servers that logically act as an enterprise secure server. The group of servers include a security naming server 430, an authentication proxy server 130, and a data server 730. The data server 730 stores digital content received from the sending system 710 for retrieval by the receiving system 720.

The sending system 710 includes a secure mail application 735 capable of using the network 740 to access the enterprise secure server 705. The sending system 710 also includes a digital certificate 126 and a public key 128 for use in obtaining authentication of the user identity of the sending system 710. The sending system 710 also includes an encrypted hardware identifier 129 for use in obtaining authentication of the hardware of the sending system 710. The sending system is protected by a firewall 745 from improper access through the network 140.

The receiving system 720 includes a secure mail application 750, a digital certificate 752, a public key 755, and an encrypted hardware identifier 757. The receiving system 720 is capable of using the secure mail application 750, the digital certificate 752, the public key 755, and the encrypted hardware identifier 757 to access the enterprise secure server 705. A firewall 760 protects the receiving system 720 from improper access from the network 140.

To exchange digital content with the receiving system 720, a user of the sending system 710 initiates the secure mail application 735 and establishes a connection with the enterprise secure server 705. The security naming server 430 assigns the authentication proxy server 130 for the session (flow 770). The secure mail application 735 of the sending system 710 provides the digital certificate 126, the public key 128, and the encrypted hardware identifier 129 to the assigned authentication proxy server 130, and the authentication proxy server 130 authenticates the user and the hardware being used (flow 772). The secure mail application 735 then sends an electronic document that includes digital content to the data server 730, which receives and stores the electronic document (flow 774).

The user of the receiving system 720 initiates the secure mail application 750 and establishes a connection with the enterprise secure server 705 (flow 780). The security naming server 430 assigns the authentication proxy server 130 for the session (also flow 780). The user and receiving system are authenticated (for example, according to process 600 of FIG. 6) and, when authenticated, the user receives notification that an electronic document is available on the enterprise security server (flow 782). The user then may retrieve the electronic document with the digital content the data server 730 (flow 784).

FIG. 8 shows an example of a communication process 800 for providing a “hardware lock” that associates a particular digital certificate with a particular client system. The hardware lock may help ensure that the secured system is accessible only through particular client systems. This also may help ensure that a digital certificate is not misappropriated and used by a user that is masquerading as another user.

The communication process 800 involves a client system 120 and an authentication proxy server 130 that authenticates a user of the client system and the client system before permitting access to a destination system. The process 800 includes a sub-process 810 for generating a hardware lock for a digital certificate and a sub-process 820 for verifying the hardware lock for a digital certificate.

The sub-process 810 for generating a hardware lock for a digital certificate generally is performed when a digital certificate is received by a user and stored on the client system 120. The sub-process 810 may be initiated by the receipt of a digital certificate and may be performed as a background process such that the user is unaware that a hardware lock is being generated for the received digital certificate.

The client system 120 generates a client identifier that uniquely identifies the client system (step 825). The client identifier may be generated based on a random number or may be based on the serial number or other type of identifier for the digital certificate. The client system sends the client identifier to the authentication proxy server (step 830), which receives and stores the client identifier (step 835).

The client system encrypts the client identifier using an encryption key based on hardware-specific information of the client system 120 (step 840). For example, the encryption key may be based on the serial number of a disk drive or other type of persistent storage device associated with the client system 120. The encryption key is used to encrypt the client identifier.

The encrypted client identifier is stored in persistent storage on the client system (step 845). The client system discards the encryption key and the unencrypted client identifier (step 850). The stored encrypted client identifier may be referred to as a hardware lock for the digital certificate.

The sub-process 820 verifies a hardware lock for a digital certificate. The sub-process 820 generally may be performed, for example, in association with the user authentication by the authentication proxy server 130.

The sub-process 820 begins when the client system 120 obtains hardware-specific information for the client system 120 and generates an encryption key based on the hardware-specific information, such as a serial number of a persistent storage device (step 855). The client system 120 accesses the stored encrypted client identifier (step 860) and uses the encryption key to decrypt the encrypted client identifier (step 865). The client system 120 then sends the decrypted client identifier to the authentication proxy server 130 (step 870).

The authentication proxy server 130 receives the decrypted client identifier (step 875) and accesses the stored client identifier (step 880). The authentication proxy server 130 then compares the received client identifier and the client identifier accessed from storage (step 890). The authentication proxy server 130 determines that the hardware lock is verified when the received client identifier corresponds to the client identifier accessed from storage (step 895). Typically, when the authentication proxy server 130 determines that the hardware lock is verified, the authentication proxy server 130 proceeds to authenticate the user based on the digital certificate, as described previously, for example, with respect to FIG. 1 or FIG. 6. When the authentication proxy server 130 cannot verify the hardware lock, the authentication proxy server 130 typically does not attempt to authenticate the user based on the digital certificate because the digital certificate has been moved from the client system that was used to create the hardware lock for the digital certificate.

Although FIGS. 1-8 illustrate an authentication proxy server that uses SSL, another protocol for managing the security of message transmission on the Internet or another type of network may be used. For example, the Transport Layer Security (TLS) protocol may be used.

Implementations may include a method or process, an apparatus or system, or computer software on a computer medium. It is intended that various modifications may be made without departing from the spirit and scope of the following claims. For example, advantageous results still could be achieved if steps of the disclosed techniques were performed in a different order and/or if components in the disclosed systems were combined in a different manner and/or replaced or supplemented by other components.

Other implementations are within the following claims.

What is claimed is:

1. A system for authenticating a user, the system comprising:
a sending system connected to a network and comprising a processor connected to a storage device, one or more input/output devices, and a port for communicating through the network wherein the processor is configured to send a digital certificate, a password associated with a user identity, and a hardware identifier that is associated with the sending system over the network to a server system and to execute software using a secure layer protocol located between an application layer and a transport layer, and
the server system connected to the network to receive the digital certificate, a password associated with a user identity, and a hardware identifier, the server system comprising a processor configured to execute software located between the application layer and the transport layer capable of authenticating, based on the received digital certificate and the received password, a user identity of the sending system and authenticating, based on the received the hardware identifier, the sending system.

2. The system of claim 1 wherein:
the processor of the sending system is further configured to send a public key over the network to the server system, and
the processor of the server system is further configured to receive the public key and the executing software is further capable of authenticating the user identify of the sending system based on both the received digital certificate and the received public key.

3. The system of claim 1 wherein the server system is further configured to:
determine permitted access to content associated with the server system; and
allow only permitted access to the content associated with the server system.

4. The system of claim 1 wherein the server system is further comprised of multiple servers and one or more processors of the server system are further configured to perform load balancing of network connection requests across the multiple servers.

5. The system of claim 1 wherein:
the sending system is further configured to create a digital signature associated with a hardware component of the sending system, the processor of the sending system is further configured to:
encrypt a hardware identifier, and
send the encrypted hardware identifier to the server system, and
the server system is further configured to receive and store the hardware identifier for use in authenticating the hardware of the sending system.

6. The system of claim 5 wherein the sending system is configured to generate the hardware identifier.

7. The system of claim 5 wherein the server system is configured to generate the hardware identifier and send the hardware identifier to the sending system.
B1. An authentication proxy server connected to a network, the authentication proxy server comprising a processor connected to a storage device, one or more input/output devices, and a port for communicating through the network wherein the processor is configured to receive a digital certificate, a password associated with a user identity, and a hardware identifier, and execute software logically operating between an application layer and a transport layer of a communications protocol stack for the purpose of authenticating, based on the received digital certificate and the received password, a user identity of a client system associated with the digital certificate and password, and authenticating, based on the received the hardware identifier, the client system.
B2. The authentication proxy server of claim B1 wherein:
digital certificate includes an identification of the certificate authority that issued the digital certificate and a public key of a sending system associated with the digital certificate such that the public key has been encrypted with the private key of the certificate authority, and
the processor is further configured to execute software logically operating between the application layer and the transport layer:
receive a public key of a sending system associated with the digital certificate,
use the public key of the certificate authority to decrypt the public key of the sending system included in the digital certificate, and
authenticate the user identity when the decrypted public key corresponds to the received public key.
C1. A client software application that communicates with the authentication proxy server of claim B1 wherein:
client software application provides a specialized communication protocol for communicating with the authentication proxy server
client software application provides a specialized authentication protocol for authenticating with the authentication proxy server
client software application provides a specialized security protocol for encrypting and decrypting communication data with the authentication proxy server.
C2. The system of claim C1 wherein:
the client software application contains an hypertext markup rendering module that will display decrypted data from the authentication proxy in a secure fashion, preventing user access to the data in any manner other than through the rendered display.
